(19) United States
(12) Patent Application Publication
(10) Pub. No.: US 2024/0262177 A1
(43) Pub. Date: Aug. 8, 2024

(54) PLACEMENT APPARATUS

(71) Applicant: Isuzu Motors Limited, Yokohama-shi, Kanagawa (JP)

(72) Inventor: Takahiro SEKIUCHI, Fujisawa-shi, Kanagawa (JP)

(73) Assignee: Isuzu Motors Limited, Yokohama-shi, Kanagawa (JP)

(21) Appl. No.: 18/429,520

(22) Filed: Feb. 1, 2024

(30) Foreign Application Priority Data
Feb. 2, 2023 (JP) 2023-014570

(51) Int. Cl. B60K 1/04

(52) U.S. Cl. CPC B60K 1/04; B60K 2001/0405

(57) ABSTRACT

A placement apparatus includes a placement portion, a positioning portion for positioning a battery, and a guidance portion having a guidance surface and disposed to protrude from the placement portion, in which the guidance portion is disposed such that the positioning portion is located at a position corresponding to a positioned portion of the battery when a contact portion of the battery making contact with the guidance surface is located at a downstream end of the guidance surface in a guiding direction.

### RELATED APPLICATION

This application claims the benefit of priority of Japan Patent Application No. 2023-014570 filed on Feb. 2, 2023, the contents of which are incorporated by reference as if fully set forth herein in their entirety.

### TECHNICAL FIELD

The present disclosure relates to a placement apparatus.

### BACKGROUND ART

Conventionally, in a vehicle including a battery, such as an electric vehicle or a hybrid vehicle, the battery is placed on a placement apparatus. In general, it has been known that a positioning portion for positioning the battery is provided in the placement apparatus.

For example, Patent Literature (hereinafter, referred to as “PTL”) 1 discloses a configuration in which a fixing protrusion that is to be engaged with an insertion hole in a module case for housing a battery is disposed on a bottom surface of a battery pack (placement apparatus).

### CITATION LIST

### Patent Literature

### PTL 1

Japanese Unexamined Patent Application Publication (Translation of PCT Application) No. 2019-506711

### SUMMARY OF INVENTION

### Technical Problem

However, in the case where the battery is positioned by the positioning portion, a variation occurs in positions of the positioning portion and the hole of the battery, and therefore, there is a scope for further enhancement in positioning accuracy.

An object of the present disclosure is to provide a placement apparatus capable of enhancing positioning accuracy for positioning a battery.

### Solution to Problem

A placement apparatus according to the present disclosure includes:
a placement portion on which a battery to be attached to a vehicle is placed;
a positioning portion disposed on or in the placement portion, the positioning portion being configured to position the battery by being engaged with a positioned portion formed in or on a bottom portion of the battery; and
a guidance portion including a guidance surface for guiding the battery toward the positioning portion, the guidance portion being disposed to protrude from the placement portion, in which
the guidance portion is disposed such that the positioning portion is located at a position corresponding to the positioned portion of the battery when a contact portion of the battery making contact with the guidance surface is located at a downstream end of the guidance surface in a guiding direction.

### ADVANTAGEOUS EFFECTS OF INVENTION

According to the present disclosure, it is possible to enhance the positioning accuracy for positioning a battery.

### BRIEF DESCRIPTION OF DRAWINGS

FIG. 1 is a diagram illustrating a vehicle including a placement apparatus according to an embodiment of the present disclosure;

FIG. 2 is a diagram of the placement apparatus according to the present embodiment as viewed in the X-direction;

FIG. 3A is a diagram for explaining movement of a battery between an inner position and an outer position;

FIG. 3B is a diagram for explaining the movement of the battery between the inner position and the outer position;

FIG. 4A illustrates a placement portion as seen in the Y-direction;

FIG. 4B is a diagram of the placement portion as seen in the X-direction;

FIG. 5A is a diagram for explaining guidance of the battery by a guidance portion;

FIG. 5B is a diagram for explaining the guidance of the battery by the guidance portion;

FIG. 6 is a diagram of a placement portion according to a variation as seen in the Y-direction;

FIG. 7A is a diagram for explaining guidance of the battery by the guidance portion according to the variation;

FIG. 7B is a diagram for explaining guidance of the battery by the guidance portion according to the variation; and

FIG. 8 is a diagram for explaining a positioning portion and a positioned portion according to another variation.

### DESCRIPTION OF EMBODIMENTS

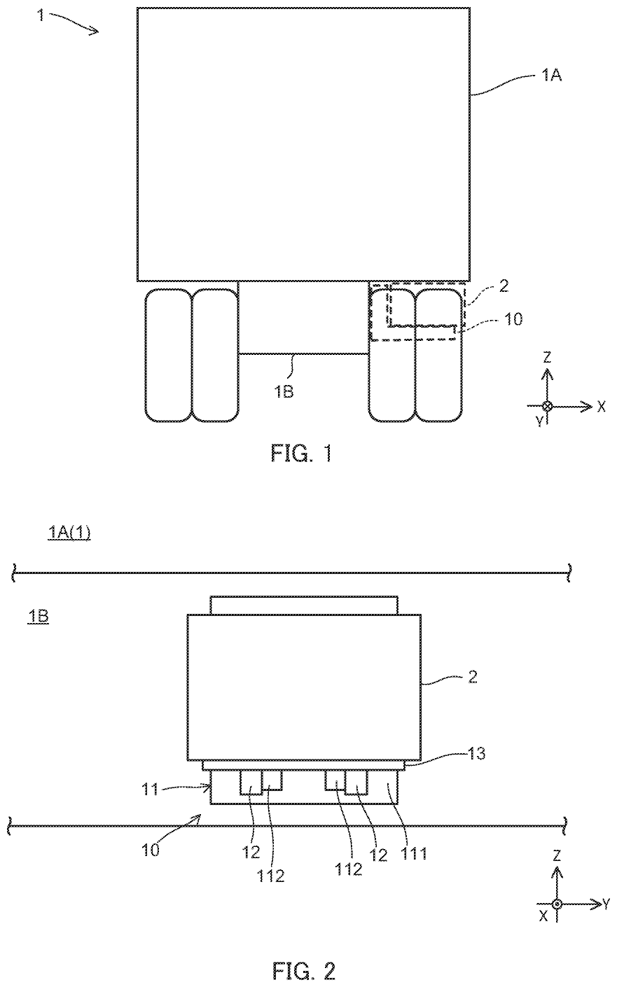

Hereinafter, embodiments of the present disclosure will be described in detail based on the drawings. FIG. 1 is a diagram illustrating a vehicle including a placement apparatus according to an embodiment of the present disclosure.

In describing the configuration of the restriction apparatus of the present embodiment, an orthogonal coordinate system (X, Y, Z) is used. The same orthogonal coordinate system (X, Y, Z) is also used for illustration of below-mentioned figures. The X-direction indicates the left-right direction of vehicle 1 on which the placement apparatus is mounted, the Y-direction indicates the front-rear direction of vehicle 1, and the Z-direction indicates the up-down direction of vehicle 1.

As illustrated in FIG. 1, vehicle 1 is such a vehicle as an electric vehicle or a hybrid vehicle which can travel by battery 2. Vehicle 1 is also a large vehicle such as a truck, and is equipped with loading platform 1A. In addition, attachment apparatus 10 for attachment of battery 2 is disposed on vehicle body 1B of vehicle 1 on which loading platform 1A is mounted.

As illustrated in FIG. 2, attachment apparatus 10 includes main body portion 11, slide portion 12, and placement portion 13.

Main body portion 11 is disposed at a position corresponding to the lower side (the −side in the Z-direction) of loading platform 1A, and includes wall portion 111 and support portions 112.

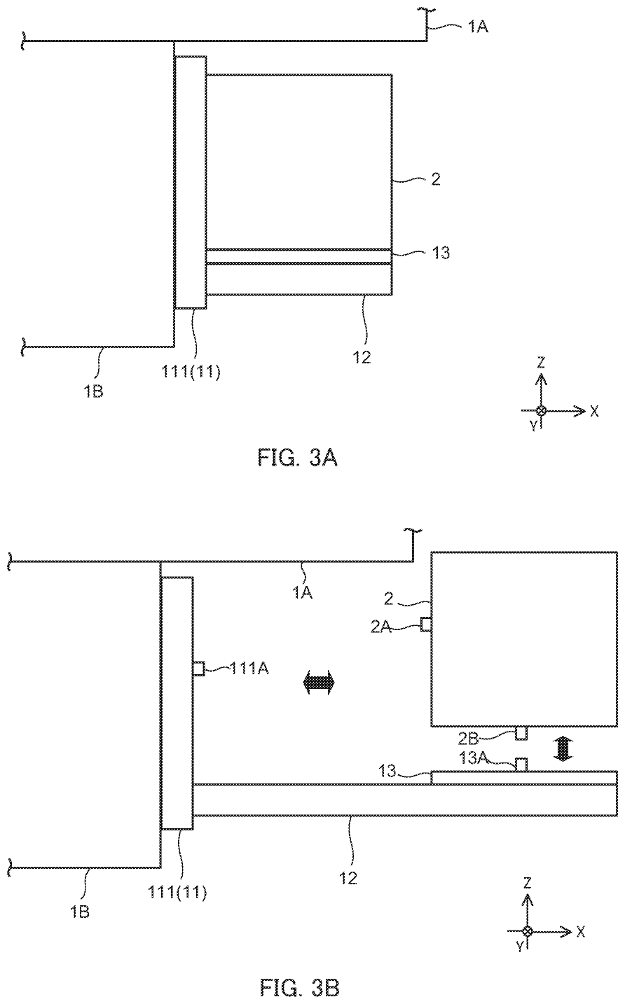

Wall portion 111 is a wall disposed along the Z-direction, and is fixed to, for example, a side surface (the +side in the X-direction) of vehicle body 1B. Wall portion 111 is provided with latch 111A that is engaged with striker 2A disposed on the side surface of battery 2 (see FIG. 3B). When latch 111A and striker 2A are engaged with each other, battery 2 is fixed to vehicle 1.

Support portions 112 are members extending toward the +side in the X-direction from the end portion of wall portion 111 on the −side in the Z-direction, and two support portions are disposed alongside with each other in the Y-direction. Support portions 112 are disposed to support placement portion 13 and battery 2 from the −side in the Z-direction when battery 2 is fixed to vehicle 1.

Slide portions 12 are a telescopic slide rail for moving battery 2 between the inner position in vehicle 1 and the outer position. Slide portions 12 are fixed respectively to support portions 112, for example.

As illustrated in FIG. 3A, slide portions 12 are located in the inner range of vehicle 1 in the X-direction when being in the most retracted state. The above-described inner position is a position where battery 2 is not located outside vehicle 1 in the X-direction, and may be, for example, a position of battery 2 (placement portion 13) when slide portions 12 are in the most retracted state.

As illustrated in FIG. 3B, when slide portions 12 are in the most extended position, the distal end portions are located on the +side in the X-direction with respect to loading platform 1A, that is, in a range outside vehicle 1. The above-described outer position is a position outside vehicle 1 in the X-direction at which battery 2 is detachable from placement portion 13, and may be, for example, a position of battery 2 (placement portion 13) in a state where slide portions 12 are most extended.

Placement portion 13 is a portion on which battery 2 attachable to and detachable from vehicle 1 is placed, and is attached to slide portion 12. Latch 13A to be engaged with striker 2B disposed on a bottom surface of battery 2 is disposed on a surface of placement portion 13 on the +side in the Z-direction. When latch 13A and striker 2B are engaged with each other, battery 2 is fixed to placement portion 13.

Further, when latch 13A and striker 2B are disengaged from each other when placement portion 13 is located in the range outside vehicle 1, battery 2 can be detached and replaced.

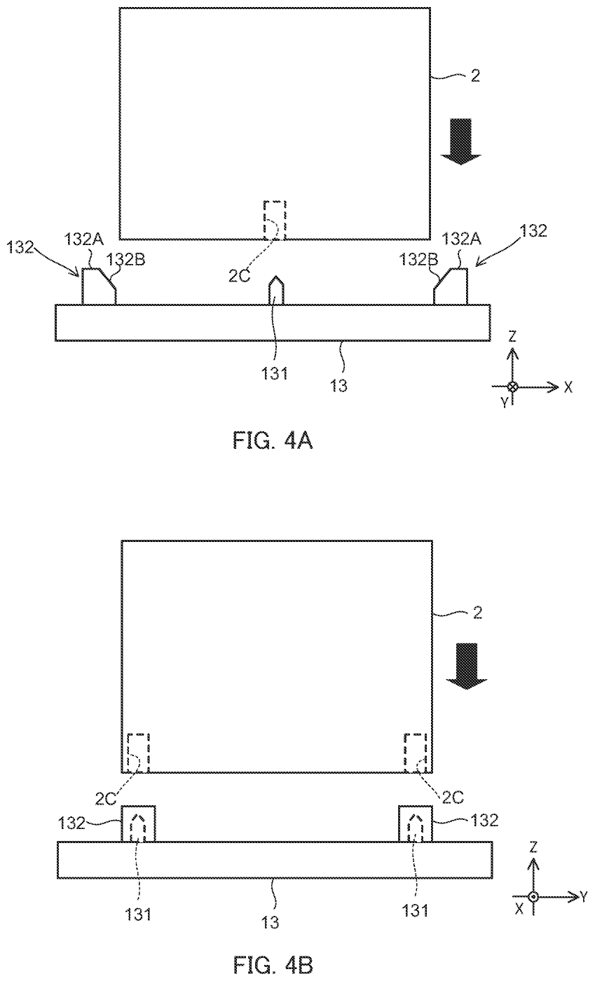

Further, as illustrated in FIGS. 4A and 4B, placement portion 13 is provided with positioning portions 131 and guidance portions 132. Placement portion 13 including positioning portions 131 and guidance portions 132 corresponds to the “placement apparatus” of the present disclosure.

Positioning portions 131 are for positioning battery 2 on placement portion 13, and are disposed respectively on end portions of placement portion 13 in the Y-direction (see FIG. 4B).

Positioning portions 131 protrude from placement portion 13 toward the +side in the Z-direction. Further, holes 2C are formed in the bottom portion of battery 2 at positions corresponding respectively to positioning portions 131, and positioning portions 131 are engageable with holes 2C. When positioning portions 131 and holes 2C are engaged with each other, battery 2 is positioned on placement portion 13. Holes 2C correspond to the “positioned portion” of the present disclosure.

Guidance portions 132 are for guiding battery 2 from the +side in the Z-direction toward positioning portions 131, and two guidance portions are disposed to correspond to each of two positioning portions 131. Two guidance portions 132 corresponding to one positioning portion 131 are disposed so as to sandwich positioning portion 131 from the opposite sides in the X-direction (see FIG. 4A), and protrude from placement portion 13. One of two guidance portions 132 corresponding to one positioning portion 131 is used to guide battery 2 toward positioning portion 131.

Note that two guidance portions 132 corresponding to one positioning portion 131 have a symmetrical structure in the X-direction. In the following description, one of two guidance portions 132 located on the +side in the X-direction will be described, and the description of guidance portion 132 located on the −side in the X-direction will be omitted. In addition, a configuration of guidance portion 132 located on the −side in the X-direction has a reverse relation between the +side and the −side in the X-direction as compared with the configuration of guidance portion 132 on the +side in the X-direction.

The end face of guidance portion 132 on the +side in the Z-direction is composed of first surface 132A and second surface 132B. First surface 132A is a surface along the XY plane.

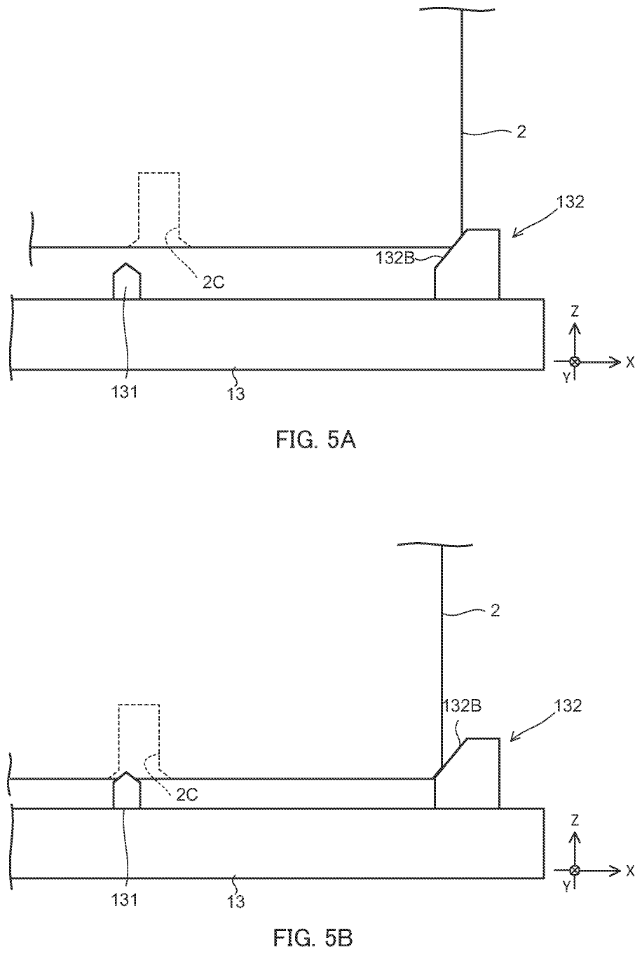

Second surface 132B is a surface located on the −side (the positioning portion 131 side) of first surface 132A in the X-direction, and is a guidance surface for guiding battery 2 toward positioning portion 131. For example, as illustrated in FIGS. 5A and 5B, a corner portion of battery 2 on the +side in the X-direction makes contact with second surface 132B and battery 2 is thus caused to move. Battery 2 is thus guided to positioning portions 131. In other words, while battery 2 is being moved in the Z-direction (first direction) toward a target position on placement portion 13, second surface 132B makes contact with battery 2 and guides it in the X-direction (second direction) orthogonal to the Z-direction. The target position may be, for example, a position (range) at which battery 2 is to be positioned on a placement surface of placement portion 13.

Second surface 132B is inclined so as to be located more on the −side in the Z-direction (on the placement portion 13 side) toward the −side in the X-direction from an end portion of first surface 132A on the −side in the X-direction. In other words, second surface 132B is inclined so as to be located more on the placement portion 13 side toward the downstream side in the guiding direction. In even other words, second surface 132B is inclined so as to be lowered toward the center side (the −side in the X-direction) in the target position.

In addition, the end portion of second surface 132B on the center side in the target position in the X-direction (the end portion of the second surface on the −side in the X-direction) may be at a corresponding position to the end portion of the target position on the +side in the X-direction.

The guiding direction is a direction in which battery 2 is directed toward positioning portion 131, and is, for example, a direction toward the −side in the X-direction. In addition, in the case where guidance portion 132 used for guiding battery 2 is one of two guidance portions 132 which is located on the −side in the X-direction, the guiding direction is a direction toward the +side in the X-direction.

Further, as illustrated in FIG. 5B, guidance portion 132 is spaced apart from positioning portion 131 such that positioning portion 131 is located at a position corresponding to hole 2C of battery 2 when the contact portion of battery 2 making contact with second surface 132B is located at a downstream end of second surface 132B in the guiding direction.

Specifically, guidance portion 132 is disposed at a position at which the position of hole 2C in the X-direction overlaps with the position of positioning portion 131 in the X-direction when the bottom portion of battery 2 is oriented along the XY plane and the contact portion of battery 2 making contact with second surface 132B is located at the downstream end of second surface 132B in the guiding direction.

With this configuration, when battery 2 is to be placed on placement portion 13, battery 2 can be guided toward positioning portion 131 with high accuracy.

That is, in the present embodiment, the positioning accuracy for positioning battery 2 can be enhanced by providing guidance portions 132.

Further, positioning portion 131 may protrude from placement portion 13 so that positioning portion 131 can enter (is engageable with) hole 2C when the contact portion of battery 2 making contact with second surface 132B is located at the downstream end of second surface 132B.

For example, the protruding amount (height) of positioning portion 131 may be set so that the distal end portion of positioning portion 131 enters hole 2C of battery 2 when the contact portion of battery 2 making contact with second surface 132B is located at the downstream end of second surface 132B.

Accordingly, since battery 2 is positioned by positioning portions 131 only by moving battery 2 along second surfaces 132B, the positioning accuracy for positioning battery 2 can be further enhanced.

Note that the movement of battery 2 relevant to the placement of battery 2 on placement portion 13 maybe performed by, for example, an apparatus that conveys battery 2, such as a robot apparatus, or may be performed manually by an operator.

Further, battery 2 maybe moved while oriented such that the bottom portion of battery 2 extends along the XY plane, or such that the bottom portion of battery 2 is inclined with respect to the XY plane.

Meanwhile, variations in the positions of the positioning portions are highly likely to occur in the configuration in which the positioning portions protruding from the placement portion are engaged with the holes in the bottom portion of the battery to position the battery. For example, in a conventional configuration without a guidance portion, measures to increase the size of a positioning portion, such as increasing the thickness or increasing the height of the positioning portion, may be taken in order to absorb this variations.

When the height of the positioning portion is increased, the influence of the inclination increases, leading to necessity to enlarge the hole in the bottom portion of the battery. Accordingly, rattle between the positioning portion and the hole increases, and the positioning accuracy for positioning the battery deteriorates.

In contrast, in the present embodiment, guidance portions 132 can accurately guide holes 2C toward positioning portions 131, and it is thus possible to enhance the positioning accuracy for positioning battery 2 as compared with the positioning accuracy in the conventional configuration.

In addition, in the present embodiment, guidance portions 132 can accurately guide holes 2C toward positioning portions 131, and it is thus not necessary to enlarge positioning portions 131 unnecessarily, and thus to increase holes 2C. Therefore, it is possible to avoid tightening the space on placement portion 13, and to achieve a simple structure.

In addition, the end portion of second surface 132B on the center side in the target position in the X-direction (the end portion on the −side in the X-direction) may be at a corresponding position to the end portion of the target position on the +side in the X-direction. It is thus possible to facilitate guidance of battery 2 to the target position aimed at in positioning.

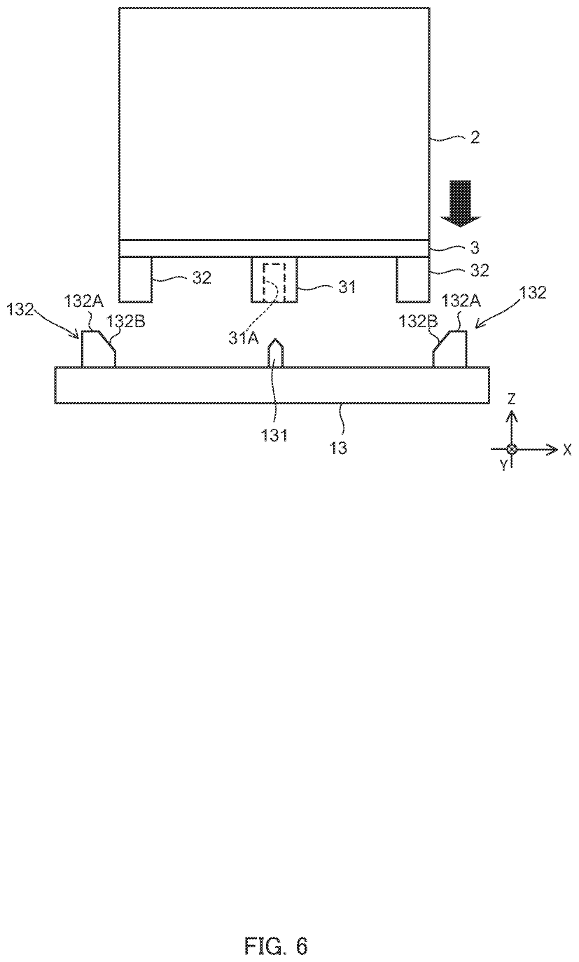

In the above-described embodiment, battery 2 is directly placed on placement portion 13, but the present disclosure is not limited thereto, and may be placed on placement portion 13 via spacer member 3 as illustrated in FIG. 6.

Spacer member 3 is a plate-shaped member, and is configured such that the battery can be disposed on the surface of the spacer member on the +side in the Z-direction. Further, insertion portions 31 and projection portions 32 are disposed on the surface of spacer member 3 on the −side in the Z-direction.

Each of insertion portions 31 is a portion into which positioning portion 131 is inserted. One insertion portion 31 is disposed to correspond to each of two positioning portions 131, and protrudes from spacer member 3. Hole 31A into which positioning portion 131 is inserted is formed in the tip end portion of insertion portion 31. Insertion portion 31 corresponds to the “bottom portion of the battery” of the present disclosure.

Projection portions 32 are portions that make contact with second surfaces 132B (guidance surfaces) of guidance portions 132, and are disposed so as to protrude from spacer member 3. Two projection portions 32 are disposed to correspond to each of two insertion portions 31. Two projection portions 32 corresponding to one insertion portion 31 are disposed, with insertion portion 31 being interposed therebetween in the X-direction.

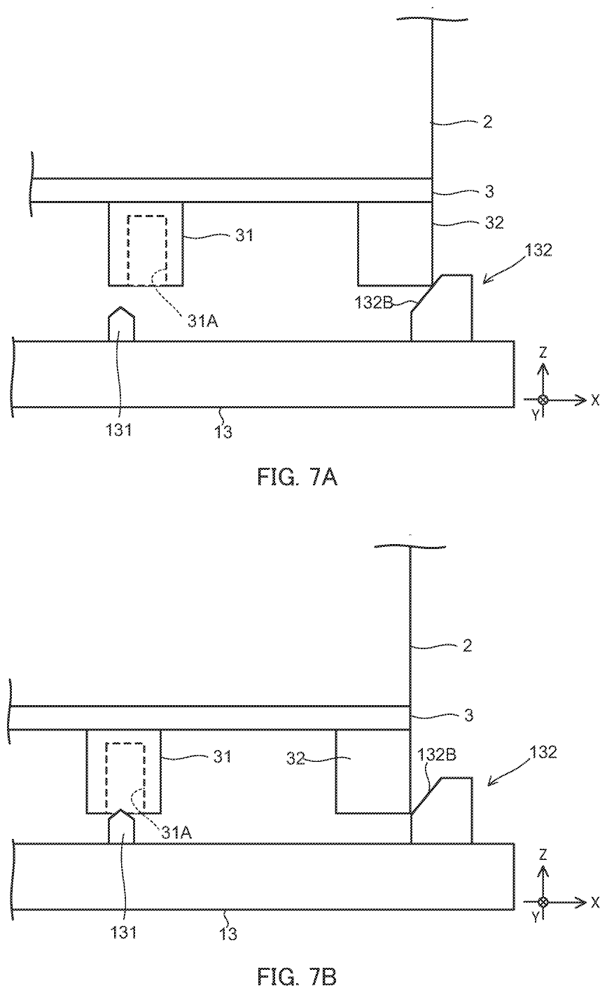

As illustrated in FIGS. 7A and 7B, when battery 2 is moved in a state where one of two projection portions 32 makes contact with second surface 132B, guidance portion 132 guides battery 2 toward positioning portion 131.

In addition, as illustrated in FIG. 7B, guidance portion 132 is spaced apart from positioning portion 131 such that positioning portion 131 is located at a position corresponding to hole 31A in insertion portion 31 of battery 2 when the contact portion (projection portion 32) of battery 2 making contact with second surface 132B is located at the downstream end of second surface 132B in the guiding direction.

With such a configuration in which guidance portions 132 are disposed, the positioning accuracy for positioning battery 2 can be enhanced.

Further, the height of each guidance portion 132 may be smaller than the height of each projection portion 32.

With this configuration, it is possible to prevent the bottom portion (spacer member 3) of battery 2 from interfering with guidance portions 132 when battery 2 is positioned.

Further, projection portions 32 are disposed on spacer member 3, but may also be disposed on the bottom surface of battery 2.

Further, in the above embodiment, guidance portion 132 has a shape having first surface 132A and second surface 132B, but the present disclosure is not limited thereto, and any shape may be used as long as it has a guidance surface.

In the above-described embodiment, two positioning portions 131 are disposed, but the present disclosure is not limited thereto, and only one positioning portion may be disposed, or three or more positioning portions may be disposed.

Further, in the above embodiment, two guidance portions are disposed to correspond to one positioning portion, but a configuration in which only one guidance portion is disposed to correspond to one positioning portion may also be applied.

Further, in the above-described embodiment, the protruding amount of each of the positioning portions is set such that the positioning portion enters the hole in the bottom portion of the battery when the battery is located at the downstream end of the guidance surface, but the present disclosure is not limited thereto. For example, the protruding amount of the positioning portion may be a protruding amount not causing the positioning portion to enter the hole in the bottom portion of the battery when the battery is located at the downstream end of the guidance surface.

Further, in the above embodiment, when the battery is located at the downstream end of the guidance surface, the position of the hole in the bottom portion of the battery in the X-direction overlaps with the position of the positioning portion in the X-direction, but the present disclosure is not limited thereto, and the position of the hole in the X-direction does not have to overlap with the position of the positioning portion in the X-direction as long as the hole is at a position beyond the center of the positioning portion, since the inclination of the positioning portion plays the same role as the guidance portion.

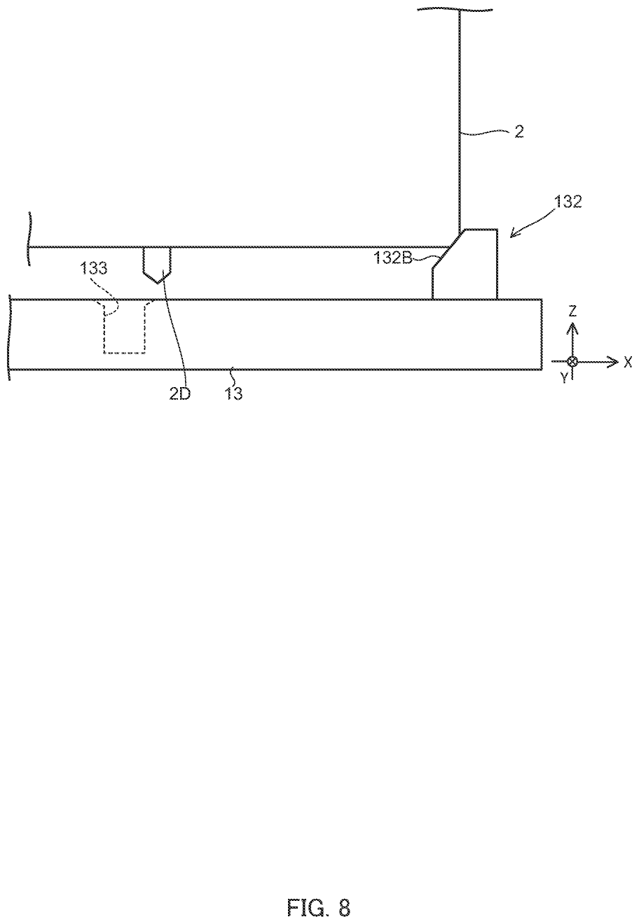

Further, in the above embodiment, the positioned portion is exemplified as hole 2C, but the present disclosure is not limited to this, and the positioned portion may be protruding portion 2D protruding from the bottom surface of the battery, for example, as illustrated in FIG. 8. In this case, the positioning portion provided in or on placement portion 13 maybe hole 133 engageable with protruding portion 2D.

The embodiments above are no more than specific examples in carrying out the present disclosure, and the technical scope of the present disclosure is not to be construed in a limitative sense due to the specific examples. That is, the present disclosure can be implemented in various forms without departing from its spirit or key features.

This application is entitled and claims the benefit of Japanese Patent Application No. 2023-014570, filed on Feb. 2, 2023, the disclosure of which including the specification, drawings and abstract is incorporated herein by reference in its entirety.

### INDUSTRIAL APPLICABILITY

The placement apparatus of the present disclosure is useful as a placement apparatus capable of enhancing the positioning accuracy for positioning a battery.

1. A placement apparatus, comprising:
a placement portion on which a battery to be attached to a vehicle is placed;
a positioning portion disposed on or in the placement portion, the positioning portion being configured to position the battery by being engaged with a positioned portion formed in or on a bottom portion of the battery; and
a guidance portion including a guidance surface for guiding the battery toward the positioning portion, the guidance portion being disposed to protrude from the placement portion, wherein
the guidance portion is disposed such that the positioning portion is located at a position corresponding to the positioned portion of the battery when a contact portion of the battery making contact with the guidance surface is located at a downstream end of the guidance surface in a guiding direction.

2. The placement apparatus according to claim 1, wherein
the guidance surface is inclined so as to be located more on the placement portion side toward a downstream side in the guiding direction.

3. The placement apparatus according to claim 1, wherein
the positioning portion is disposed on or in the placement portion such that the positioning portion is engageable with the positioned portion when the contact portion is located at the downstream end.

4. The placement apparatus according to claim 1, wherein:
the contact portion of the battery making contact with the guidance surface is a projection portion disposed on the bottom portion of the battery, and
a height of the guidance portion is smaller than a height of the projection portion.

5. A placement apparatus, comprising:
a placement portion on which a battery attachable to and detachable from a vehicle is placed; and
a guidance portion including a guidance surface that, while the battery is being moved in a first direction toward a target position on the placement portion, makes contact with the battery to guide the battery in a second direction orthogonal to the first direction, wherein
the guidance surface is inclined to be lowered on a center side in the target position, and
an end portion of the guidance surface on the center side in the target position is located at a position corresponding to an end portion of the target position in the second direction.
